(19) United States
(12) Patent Application Publication
(10) Pub. No.: US 2021/0279860 A1
(43) Pub. Date: Sep. 9, 2021

(54) Adaptive Feeding Device and Method for Swimming Fish Based on Photo-acoustic Coupling Technology

(71) Applicant: ZHEJIANG UNIVERSITY, Hangzhou (CN)

(72) Inventors: Zhangying Ye, Hangzhou (CN); Dan Wei, Hangzhou (CN); Jian Zhao, Hangzhou (CN); Zhiying Han, Hangzhou (CN); Zequn Peng, Hangzhou (CN); Songming Zhu, Hangzhou (CN)

(21) Appl. No.: 17/329,174

(22) Filed: May 25, 2021

Related U.S. Application Data
(63) Continuation of application No. PCT/CN2021/071839, filed on Jan. 14, 2021.

(30) Foreign Application Priority Data
Jan. 15, 2020 (CN) 202010044382.3

(51) Int. Cl. G06T 7/00; A01K 61/80

(52) U.S. Cl. CPC G06T 7/0004; A01K 63/04; A01K 61/80

(57) ABSTRACT

Disclosed is an adaptive feeding device for swimming fish based on photo-acoustic coupling technology. The device comprises a recirculating aquaculture pond, a recirculating water treatment system, a high-definition waterproof camera, a feeding machine having a feeding port, and a LED supplement light, a PLC, a digital signal processor, a display, and a hydrophone. The device mainly uses the combination of machine vision technology and acoustic technology to adaptively and accurately analyze and evaluate the fish's real-time feeding desire during the feeding process, so as to formulate feeding strategies. The device of the present invention has simple structure, precise and simple method. The self-adaptive feeding device and method of the present invention are suitable for recirculating aquaculture mode and can effectively solve the problem of feed feeding in the existing recirculating aquaculture system.

### CROSS-REFERENCE TO RELATED APPLICATIONS

This application is a continuation of and claims priority to International (PCT) Patent Application No. PCT/CN2021/071839, filed on Jan. 14, 2021, entitled “Adaptive Feeding Device and Method for Swimming Fish Based on Photo-acoustic Coupling Technology” which claims priority to Chinese Patent Application No. CN202010044382.3, filed on Jan. 15, 2020. These identified applications are hereby incorporated by references.

### TECHNICAL FIELD

The present disclosure relates to the technical field of industrial recirculating water aquaculture feeding machinery, in particular to an adaptive feeding device and method for swimming fishes that integrate optical and acoustic technology. The device may automatically adjust the feeding time and feeding amount in real time according to the need of the swimming fishes.

### BACKGROUND

As a form of high-density aquaculture, industrial recirculating aquaculture has very strict requirements for water quality regulation and control. Feed feeding, as an indispensable part of the daily work of recirculating aquaculture, has a great impact on water quality parameters. At present, the feeding of industrial recirculating aquaculture feed mainly relies on two manners: manual feeding, and timing and quantitative feeding by machine. The feeding amount and feeding time cannot be automatically adjusted according to the actual hunger level of the fish, resulting in the feeding amount and the actual fish. Feeding needs are not matched. When the feeding amount is less than the actual needs of the fish, serious competition for food will occur, causing collisions between the fishes and even causing surface damage to the fish. In addition, when some fish which are not good at scrambling for food may not reach fullness for a long time, its growth rate will be much lower than that of other fish in the shoal, causing serious polarization of fish growth. Fish with damage on the surface and weak fish are more likely to be infected with certain fish diseases, making the aquaculture water environment bear greater pressure, having an adverse effect on the growth of fish. When the feeding amount is greater than the actual feeding demand of the fish, it will not only increase the breeding cost, but the excess feed will also seriously pollute the breeding environment, affecting the optimal growth state of the fish and restricting the growth and welfare of the fish. Therefore, the amount of feed should be as consistent as possible with the actual feeding needs of the fish. The breeding density of juvenile fish is higher in the recirculating aquaculture system, and the individual juvenile fish is weaker and more sensitive to the growth environment. In the process of aquaculture production, the amount of feed must not only meet the growth needs of juvenile fish, but also create good growth conditions for them.

Computer vision technology is a technology that can determine the feeding needs of fish in real time, and is convenient to cooperate with feeding machines for feeding operations. However, for juvenile fish, their small body size weakens the visual information change generated during the feeding process when the number of fish in feeding is small and the feeding activity of the fish becomes weak. In this condition, the vision technology may not correctly determine the feeding schedules. This defect is more obvious in poor lighting conditions and turbid water bodies. Acoustic technology can collect the audio information generated by fish during the feeding process. The collection process is not affected by light and water turbidity. With the decrease in the number of fish and the desire to eat, the sound pressure level of different audio frequencies will change regularly, and the changes in the intensity of fish feeding can be better judged based on this.

### SUMMARY OF THIS INVENTION

On basis of the problem as discussed, the present disclosure provides an adaptive feeding device and method for swimming fish based on photo-acoustic coupling technology, which combines machine vision technology with acoustic technology, and automatically switches control according to fish growth and feeding needs to achieve precise feeding operations, provide fish with food and nutrients suitable for growth, and create good growth environmental conditions. The device can automatically adjust the feeding amount and feeding time according to the actual feeding needs of the fish, and provide a good reference and technical support for the rationalized feeding operation of recirculating aquaculture.

The adaptive feeding device and method for swimming fish based on photo-acoustic coupling technology comprises a recirculating aquaculture pond, a recirculating water treatment system, a high-definition waterproof camera, a feeding machine having a feeding port, and a LED supplement light, a PLC, a digital signal processor, a display, and a hydrophone.

The recirculating water treatment system is installed outside the recirculating aquaculture pond.

The high-definition waterproof camera is installed directly above the recirculating aquaculture pond, and the high-definition waterproof camera is connected to an input end of the digital signal processor.

The feeding machine is installed directly above the recirculating aquaculture pond, and there is the feeding port of the feeding machine at both sides of the high-definition waterproof camera. In addition, there are several LED supplementary lights under the feeding machine (e.g. six LED supplementary lights and two feeding ports are evenly distributed on a lower circumference of the feeding machine). Furthermore, the feeding machine is connected to an output end of the PLC.

The hydrophone is secured inside the recirculating aquaculture pond and connected to the input end of the digital signal processor.

An output end of the digital signal processor is connected to the input end of the PLC and the display at the same time.

The feeding method using the above device for adaptive feeding the swimming fish comprises the following steps:

1) transmitting, by the high-definition waterproof camera, real-time video images captured by the high-definition waterproof camera to a digital signal processor;

2) receiving and pre-processing, by the digital signal processor, the video images; extracting an image information of each frame of the video image; and performing threshold segmentation on the video image; wherein “ostu threshold segmentation” method is used, letting g (x)=w₀^{αβ}*(u₀−u)²+w₁^{αβ}*(u₁−u)²; when g (x) takes the maximum value, x is the segmentation threshold. The foreground spot and background spot are divided by x, wherein when the gray level is greater than x, it is the background spot; when the gray level is lower than x, it is the foreground spot; wherein w₀ is the proportion of the image occupied by the foreground spot, u₀ is the average gray level of the foreground spot; w₁ is the proportion of the image occupied by the background spot; u₁ is the average gray level of the background spot; u=w₀*u₀+w₁*u₁ is the illumination coefficient of the current frame, which is determined by the illumination intensity of the breeding environment; the value range of α is 0 to 1; the stronger the light is, the greater the value of α; β is the turbidity coefficient of the aquaculture water body, which is determined by the turbidity degree of the aquaculture water body; the value range of β is 0 to 1; the higher the turbidity degree of the aquaculture water body, the smaller the value of β;

3) based on the above threshold and segmentation result, calculating the number S1 of the pixel representing the fish body information, i.e. the foreground spot, in the video frame; if S1>0.5S, where S is the number of all pixels in the frame image, the digital signal processor inputs the processing results to the PLC, and the PLC controls the feeding machine to work and feed for 10 seconds;

4) after the feeding starts, the camera still normally transmits real-time video information to the digital signal processor; the digital signal processor extracts the picture information of each frame in the real-time video, and divides each frame into two parts: the feeding center area T1 and the feeding edge area T2; wherein the feeding center area T1 is centered on the center of the recirculating aquaculture pool, and the radius is:

$$r = 0.8 * \frac{{\sum }_{i = 1}^{n} {l}_{i}}{n {l}_{max}} {r}_{0} ,$$

wherein r₀ is the radius of the circulation pool; n is the number of fish cultured in the recirculating aquaculture pond, lᵢ is the body length of the ith fish in the recirculating aquaculture pond; and lₘₐₓ is the maximum body length of the fish in the recirculating aquaculture pond; the areas outside the aquaculture ponds are all marginal areas of feeding, except the feeding center area;

5) calculating the optical flow change values F1ₜ and F2ₜ between adjacent video frames in the two areas by using the dense optical flow algorithm; setting the movement vector with coordinate (i, j) in the area T1 to (xᵢⱼ, yᵢⱼ); and setting the movement vector with coordinate (i′, j′) in the area T2 to (xᵢⱼ′, yᵢⱼ′); wherein the optical flow change values of the two areas are:

$$F {1}_{t} = \frac{{Σ}_{i j} \sqrt{{x}_{ij}^{2} + {y}_{ij}^{2}}}{{N}_{1}} and F {2}_{t} = \frac{{ }_{{ }^{{ }_{{\sum }_{{i}^{′} {j}^{′}}} \sqrt{{( {x}_{ij}^{′} )}^{2} + {( {y}_{ij}^{′} )}^{2}}}}}{{N}_{2}} ;$$

wherein, N₁ is the total number of pixels in the area T1; N₂ is the total number of pixels in the area T2; the dynamic change of the optical flow change value over time will be calculated and displayed on the display;

6) comparing the mean values F1 and F2 of the optical flow changes in the two areas calculated within the time period t with the feeding center area threshold FT1 and feeding edge area threshold FT2:

$$F 1 = \frac{{Σ}_{i = 1}^{t} F {1}_{t}}{t - 1} , F 2 = \frac{{Σ}_{i = 1}^{t} F {2}_{t}}{t - 1} ; F T 1 = 1.4 μ F {1}^{′} , FT 2 = 1.2 μ F {2}^{′} ;$$

wherein, F1′ and F2′ are the mean values of optical flow changes in area T1 and T2 in the non-feeding state, respectively; μ is the comprehensive water quality correction factor,

$$μ = 1 + \vert \frac{Δ T}{T} \vert + \vert \frac{Δ {P}_{h}}{{P}_{h}} \vert + \vert \frac{Δ {D}_{o}}{{D}_{o}} \vert ;$$

wherein, T is the standard temperature of aquaculture water; ΔT is the difference between the temperature of the water body and the standard temperature T; Pₕ is the standard pH of the aquaculture water; ΔPₕ is the difference between the pH of the water body and the standard pH of the water; Dₒ is the standard dissolved oxygen content of the aquaculture water; ΔDₒ is the difference between the dissolved oxygen content of the water body and the standard dissolve oxygen content of the water body; if F1>FT1 and F2<FT2, the next feeding will be carried out; the feeding time is the same as the previous one, and the feeding amount is:

$$m = ( 0.65 * \frac{F 1 - F T 1}{F T 1} + 0.35 * \frac{F T 2 - F 2}{F T 2} ) {m}_{0} ;$$

wherein m₀ is the minimum feeding amount to meet the normal growth and nutritional requirements of fish;

7) if

$${F}_{1} < ( 1 + \frac{{Σ}_{i}^{n} {l}_{i}}{{nl}_{max}} ) F {T}_{1} or {F}_{2} > ( 1 - \frac{{Σ}_{i}^{n} {l}_{i}}{{nl}_{max}} ) F {T}_{2} ,$$

then the digital signal processor will automatically switches the machine vision control feeding to the acoustic system for feeding control; the hydrophone collects 1500-3000 Hz audio information generated during fish feeding and transmits it to the digital signal processor in real time; when the collected audio sound pressure level effective value Z>ZT, the system starts feeding; wherein, ZT is the effective valve threshold of the audio sound pressure level to determine the feeding; ZT=(60*log₁₀ T)dB re 1 uPa; wherein T is the real-time water temperature; the feeding amount is:

$$m = ( 0.5 + \frac{Z - Z T}{Z T} ) {m}_{0} \text{;}$$

8) if Z<ZT, then sending, by the digital signal controller, a stop feeding instruction to the PLC, and controlling, by the PLC, the feeding machine to stop working; automatically switching, by the PLC, the feeding control system to the machine vision, and waiting for the start of the next feeding work.

A complete adaptive feeding device of the present invention comprises a feeding machine, a PLC, a high-definition waterproof camera, a hydrophone, a digital signal processor and a display, which can automatically switch the feeding control mode according to the actual feeding situation of the fish. This achieves the purpose of intelligent and precise feeding.

According to the changes in the actual breeding environment, the PLC is used to control the LED lights evenly distributed around the high-definition waterproof camera, which not only provides suitable lighting conditions for the adaptive feeding system, but also automatically adjusts the brightness to provide a suitable growth light environment for fish.

The advantage of the present disclosure is as follows.

The swimming fish adaptive feeding device based on photo-acoustic coupling of the present invention has simple structure and simple control mode. It can not only use machine vision technology to determine the actual appetite of fish for feeding, but also weaken the appetite of fish as the fish's appetite for food intake to a certain extent, it can automatically switch to the feeding method controlled by acoustic technology, which can accurately control the feeding time and feeding amount according to the fish's appetite and appetite. It is especially suitable for the breeding and feeding process of fish juveniles to ensure the growth of fish. In the case of required nutritional conditions, more attention should be paid to the welfare of fish, which can provide good environmental conditions for fish growth.

### BRIEF DESCRIPTION OF THE DRAWINGS

FIG. 1 is a schematic diagram of a photo-acoustic coupling swimming fish adaptive feeding device applied to circulation water.

In the drawings:

1—recirculating aquaculture pond; 2—recirculating water treatment system; 3—high—definition waterproof camera; 4—feeding port of feeding machine; 5—feeding machine; 6—LED supplement light; 7—PLC; 8—digital signal processor; 9—display; 10—hydrophone.

### DETAILED DESCRIPTION OF THE DISCLOSURE

The present disclosure will be described in detail below in conjunction with the drawings. The following specific embodiments are used to illustrate the present invention, but not to limit the scope of the present invention.

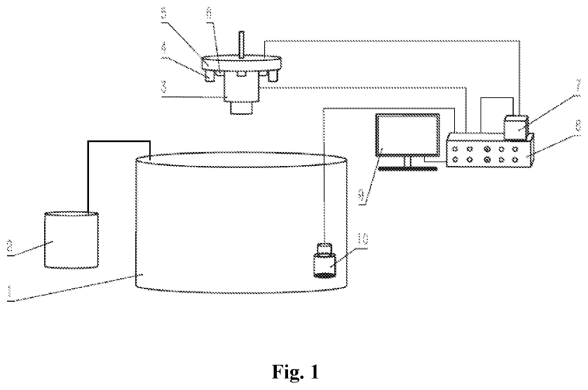

Referring to FIG. 1, it is a specific example of a swimming fish adaptive feeding device based on photo-acoustic coupling technology according to one embodiment of the present disclosure. The adaptive feeding device comprises a recirculating aquaculture pond 1, a recirculating water treatment system 2, a high-definition waterproof camera 3, and a feeding machine 5 having a feeding port 4, a LED fill light 6, a PLC 7, a digital signal processor 8, a display 9, and a hydrophone 10.

The recirculating water treatment system 2 is installed on the outer left side of the recirculating aquaculture pond 1. The recirculating water treatment system 2 sends the aquaculture wastewater to the recirculating aquaculture pond 1 after a series of operations such as filtration, sterilization, and aeration. This greatly increases the resource utilization.

The high-definition waterproof camera 3 is installed directly above the middle of the recirculating aquaculture pond 1 and fixed directly under the feeding machine 5. The high-definition waterproof camera 3 is connected to the input end of the digital signal processor 8. The installation position of the camera can ensure that the sight of the camera may cover the entire feeding area. The camera is directly fixed under the feeding machine, which is convenient for loading and unloading without the need for additional mounting frames.

The feeding machine 5 is installed directly above the recirculating aquaculture pond 1, and there is a feeding port 4 of the feeding machine on both sides of the high-definition waterproof camera 3. There are two feeding ports 4 arranged on the lower circumference of the feeding machine 5. Additionally, there are six LED supplementary lights 6 evenly distributed on the lower circumference of the feeding machine 5 along with the two feeding ports 4. Furthermore, the feeding machine 5 is connected to the output end of the PLC 7. Two feeding ports of the feeding machine can ensure that the feed can evenly cover the entire feeding area, and appropriately expand the feeding area. The installation position of the LED supplementary light will not affect the work of the camera and the feeding machine.

The uniformly distributed LED supplementary light 6 can change the brightness according to the change of the actual breeding environment light, which not only provides suitable lighting conditions for the adaptive feeding system, but also provides a suitable growth light environment for fish.

The hydrophone 10 is secured at the lower right inside the recirculating aquaculture pond 1 and connected to the input of the digital signal processor 8. The hydrophone can collect the sound information emitted by the fish during feeding and transmit it to the digital signal processor.

The output end of the digital signal processor 8 is connected to the input end of the PLC 7 and the display 9 at the same time. The digital signal processor receives the image information input by the camera and the sound information input by the hydrophone and performs corresponding processing. Firstly, analyzing the fish's real-time feeding desire through the image processing technology, and determining the feeding machine to perform feeding operations. If the digital signal processor determines that the feeding desire is strong, the machine vision technology controls the feeding process, which includes feeding time and feeding amount, otherwise it will be automatically switched to acoustic technology control. The digital signal processor transmits the processing results to the PLC to control the feeding machine, and on the other hand, it can display the processing results on the display, which is more intuitive.

A feeding method using the above device for adaptive feeding the swimming fish comprises the following steps:

1) transmitting, by the high-definition waterproof camera 3, real-time video images captured by the high-definition waterproof camera to a digital signal processor 8;

2) receiving and pre-processing, by the digital signal processor 8, the video images; extracting an image information of each frame of the video image; and performing threshold segmentation on the video image; letting g(x)=w₀^{αβ}*(u₀−u)²+w₁^{αβ}*(u₁−u)²; when g(x) takes the maximum value, x is the segmentation threshold. The foreground spot and background spot are divided by x, wherein when the gray level is greater than x, it is the background spot; when the gray level is lower than x, it is the foreground spot; wherein w₀ is the proportion of the image occupied by the foreground spot, u₀ is the average gray level of the foreground spot; w₁ is the proportion of the image occupied by the background spot; u₁ is the average gray level of the background spot; u=w₀*u₀+w₁*u₁ is the illumination coefficient of the current frame, which is determined by the illumination intensity of the breeding environment; the value range of α is 0 to 1; the stronger the light is, the greater the value of α; β is the turbidity coefficient of the aquaculture water body, which is determined by the turbidity degree of the aquaculture water body; the value range of β is 0 to 1; the higher the turbidity degree of the aquaculture water body, the smaller the value of β;

3) based on the above threshold and segmentation result, calculating the number S1 of the pixel representing the fish body information, i.e. the foreground spot, in the video frame; if S1>0.5S, where S is the number of all pixels in the frame image, the digital signal processor inputs the processing results to the PLC, and the PLC controls the feeding machine to work and feed for 10 seconds;

4) after the feeding starts, the camera still normally transmits real-time video information to the digital signal processor; the digital signal processor extracts the picture information of each frame in the real-time video, and divides each frame into two parts: the feeding center area T1 and the feeding edge area T2; wherein the feeding center area T1 is centered on the center of the recirculating aquaculture pool, and the radius is:

$$r = 0.8 * \frac{{Σ}_{i = 1}^{n} {l}_{i}}{n {l}_{max}} {r}_{0} ,$$

wherein r₀ is the radius of the circulation pool; n is the number of fish cultured in the recirculating aquaculture pond, lᵢ is the body length of the ith fish in the recirculating aquaculture pond; and lₘₐₓ is the maximum body length of the fish in the circulating water aquaculture pond; the areas outside the aquaculture ponds are all marginal areas of feeding, except the feeding center area;

5) calculating the optical flow change values F1ₜ and F2ₜ between adjacent video frames in the two areas by using the dense optical flow algorithm; setting the movement vector with coordinate (i, j) in the area T1 to (xᵢⱼ, yᵢⱼ); and setting the movement vector with coordinate (i′, j′) in the area T2 to (xᵢⱼ′, yᵢⱼ′); wherein the optical flow change values of the two areas are:

$$F {1}_{t} = \frac{{\sum }_{ij} \sqrt{{x}_{ij}^{2} + {y}_{ij}^{2}}}{{N}_{1}} and F {2}_{t} = \frac{{\sum }_{{i}^{′} {j}^{′}} \sqrt{{( {x}_{ij}^{′} )}^{2} + {( {y}_{ij}^{′} )}^{2}}}{{N}_{2}} \text{;}$$

wherein, N₁ is the total number of pixels in the area T1; N₂ is the total number of pixels in the area 12; the dynamic change of the optical flow change value over time will be calculated and displayed on the display;

6) comparing the mean values F1 and F2 of the optical flow changes in the two areas calculated within the time period t with the feeding center area threshold FT1 and feeding edge area threshold FT2:

$$F 1 = \frac{{\sum }_{i = 1}^{t} F {1}_{t}}{t - 1} , F 2 = \frac{{\sum }_{i = 1}^{t} F {2}_{t}}{t - 1} \text{;}$$

### FT1=1.4μF1′, FT2=1.2μF2′;

wherein, F1′ and F2′ are the mean values of optical flow changes in area T1 and T2 in the non-feeding state, respectively; μ is the comprehensive water quality correction factor,

$$μ = 1 + \vert \frac{Δ T}{T} \vert + \vert \frac{Δ {P}_{h}}{{P}_{h}} \vert + \vert \frac{Δ {D}_{o}}{{D}_{o}} \vert \text{;}$$

wherein, T is the standard temperature of aquaculture water; ΔT is the difference between the temperature of the water body and the standard temperature T; Pₕ is the standard pH of the aquaculture water; ΔPₕ is the difference between the pH of the water body and the standard pH of the water; Dₒ is the standard dissolved oxygen content of the aquaculture water; ΔDₒ is the difference between the dissolved oxygen content of the water body and the standard dissolve oxygen content of the water body; if F1>FT1 and F2<FT2, the next feeding will be carried out; the feeding time is the same as the previous one, and the feeding amount is:

$$m = ( 0.65 * \frac{F 1 - FT 1}{FT 1} + 0.35 * \frac{FT 2 - F 2}{FT 2} ) {m}_{0} \text{;}$$

wherein m₀ is the minimum feeding amount to meet the normal growth and nutritional requirements of fish;

7) if

$${F}_{1} < ( 1 + \frac{{\sum }_{i}^{n} {l}_{i}}{{nl}_{max}} ) {FT}_{1} or {F}_{2} > ( 1 - \frac{{\sum }_{i}^{n} {l}_{i}}{{nl}_{max}} ) {FT}_{2} ,$$

then the digital signal processor will automatically switches the machine vision control feeding to the acoustic system for feeding control; the hydrophone collects audio information (1500-3000 Hz) generated during fish feeding and transmits it to the digital signal processor in real time; when the collected audio sound pressure level effective value Z>ZT, the system starts feeding; wherein, ZT is the effective valve threshold of the audio sound pressure level to determine the feeding; ZT=(60*log₁₀ T)dB re 1 uPa; wherein T is the real-time water temperature; the feeding amount is:

$$m = ( 0.5 + \frac{Z - ZT}{ZT} ) {m}_{0} \text{;}$$

8) if Z<ZT, then sending, by the digital signal controller, a stop feeding instruction to the PLC, and controlling, by the PLC, the feeding machine to stop working; automatically switching, by the PLC, the feeding control system to the machine vision, and waiting for the start of the next feeding work.

The foregoing are only specific embodiments of the present disclosure, and various changes and modifications made without departing from the concept and scope of the present disclosure, and all equivalent technical solutions also belong to the scope of the present invention.

What is claimed is:

1. An adaptive feeding device for swimming fish based on photo-acoustic coupling technology, comprising: a recirculating aquaculture pond, a recirculating water treatment system, a high-definition waterproof camera, a feeding machine having a feeding port, and a LED supplement light, a PLC, a digital signal processor, a display, and a hydrophone;
wherein the recirculating water treatment system is installed outside the recirculating aquaculture pond;
the high-definition waterproof camera is installed directly above the recirculating aquaculture pond, and the high-definition waterproof camera is connected to an input end of the digital signal processor;
the feeding machine is installed directly above the recirculating aquaculture pond, and there is the feeding port of the feeding machine at both sides of the high-definition waterproof camera;
there are several LED supplementary lights under the feeding machine;
the feeding machine is connected to an output end of the PLC;
the hydrophone is secured inside the recirculating aquaculture pond and connected to the input end of the digital signal processor;
an output end of the digital signal processor is connected to the input end of the PLC and the display at the same time.

2. A method using the device of claim 1 for adaptive feeding the swimming fish, comprising the following steps:
1) transmitting, by the high-definition waterproof camera, real-time video images captured by the high-definition waterproof camera to a digital signal processor;
2) receiving and pre-processing, by the digital signal processor, the video images; extracting an image information of each frame of the video image; and performing threshold segmentation on the video image; letting g(x)=w₀^{αβ}*(u₀−u)²+w₁^{αβ}*(u₁−u)²; when g(x) takes the maximum value, x is the segmentation threshold; the foreground spot and background spot are divided by x, wherein when the gray level is greater than x, it is the background spot; when the gray level is lower than x, it is the foreground spot; wherein w₀ is the proportion of the image occupied by the foreground spot, u₀ is the average gray level of the foreground spot; w₁ is the proportion of the image occupied by the background spot; u₁ is the average gray level of the background spot; u=w₀*u₀+w₁*u₁ is the illumination coefficient of the current frame, which is determined by the illumination intensity of the breeding environment; the value range of α is 0 to 1; the stronger the light is, the greater the value of α; β is the turbidity coefficient of the aquaculture water body, which is determined by the turbidity degree of the aquaculture water body; the value range of β is 0 to 1; the higher the turbidity degree of the aquaculture water body, the smaller the value of β;
3) based on the above threshold and segmentation result, calculating the number S1 of the pixel representing the fish body information, i.e. the foreground spot, in the video frame; if S1>0.5S, where S is the number of all pixels in the frame image, the digital signal processor inputs the processing results to the PLC, and the PLC controls the feeding machine to work and feed for 10 seconds;
4) after the feeding starts, the camera still normally transmits real-time video information to the digital signal processor; the digital signal processor extracts the picture information of each frame in the real-time video, and divides each frame into two parts: the feeding center area T1 and the feeding edge area T2; wherein the feeding center area T1 is centered on the center of the recirculating aquaculture pool, and the radius is:
$$r = 0.8 * \frac{{\sum }_{i = 1}^{n} {l}_{i}}{{nl}_{max}} {r}_{0} ,$$
wherein r₀ is the radius of the circulation pool; n is the number of fish cultured in the recirculating aquaculture pond, lᵢ is the body length of the ith fish in the recirculating aquaculture pond; and lₘₐₓ is the maximum body length of the fish in the recirculating aquaculture pond; the areas outside the aquaculture ponds are all marginal areas of feeding, except the feeding center area;
5) calculating the optical flow change values F1ₜ and F2ₜ between adjacent video frames in the two areas by using the dense optical flow algorithm; setting the movement vector with coordinate (i, j) in the area T1 to (xᵢⱼ, yᵢⱼ); and setting the movement vector with coordinate (i′, j′) in the area T2 to (xᵢⱼ′, yᵢⱼ′); wherein the optical flow change values of the two areas are:
$$F {1}_{t} = \frac{{\sum }_{ij} \sqrt{{x}_{ij}^{2} + {y}_{ij}^{2}}}{{N}_{1}} and F {2}_{t} = \frac{{\sum }_{{i}^{′} {j}^{′}} \sqrt{{( {x}_{ij}^{′} )}^{2} + {( {y}_{ij}^{′} )}^{2}}}{{N}_{2}} \text{;}$$
wherein, N₁ is the total number of pixels in the area T1; N₂ is the total number of pixels in the area T2; the dynamic change of the optical flow change value over time will be calculated and displayed on the display;
6) comparing the mean values F1 and F2 of the optical flow changes in the two areas calculated within the time period t with the feeding center area threshold FT1 and feeding edge area threshold FT2:
$$F 1 = \frac{{\sum }_{i = 1}^{t} F {1}_{t}}{t - 1} , F 2 = \frac{{\sum }_{i = 1}^{t} F {2}_{t}}{t - 1} \text{;}$$
FT1=1.4μF1′, FT2=1.2μF2′;
wherein, F1′ and F2′ are the mean values of optical flow changes in area T1 and T2 in the non-feeding state, respectively; μ is the comprehensive water quality correction factor,
$$μ = 1 + \vert \frac{Δ T}{T} \vert + \vert \frac{Δ {P}_{h}}{{P}_{h}} \vert + \vert \frac{Δ {D}_{o}}{{D}_{o}} \vert \text{;}$$
wherein, T is the standard temperature of aquaculture water; ΔT is the difference between the temperature of the water body and the standard temperature T; Pₕ is the standard pH of the aquaculture water; ΔPₕ is the difference between the pH of the water body and the standard pH of the water; Dₒ is the standard dissolved oxygen content of the aquaculture water; ΔDₒ is the difference between the dissolved oxygen content of the water body and the standard dissolve oxygen content of the water body; if F1>FT1 and F2<FT2, the next feeding will be carried out; the feeding time is the same as the previous one, and the feeding amount is:
$$m = ( 0.65 * \frac{F 1 - FT 1}{FT 1} + 0.35 * \frac{FT 2 - F 2}{FT 2} ) {m}_{0} \text{;}$$
wherein m₀ is the minimum feeding amount to meet the normal growth and nutritional requirements of fish;
7) if
$${F}_{1} < ( 1 + \frac{{\sum }_{i}^{n} {l}_{i}}{{nl}_{max}} ) {FT}_{1} or {F}_{2} > ( 1 - \frac{{\sum }_{i}^{n} {l}_{i}}{{nl}_{max}} ) {FT}_{2} ,$$
then the digital signal processor will automatically switches the machine vision control feeding to the acoustic system for feeding control; the hydrophone collects 1500-3000 Hz audio information generated during fish feeding and transmits it to the digital signal processor in real time; when the collected audio sound pressure level effective value Z>ZT, the system starts feeding; wherein, ZT is the effective valve threshold of the audio sound pressure level to determine the feeding; ZT=(60*log₁₀ T)dB re 1 uPa; wherein Tis the real-time water temperature; the feeding amount is:
$$m = ( 0.5 + \frac{Z - ZT}{ZT} ) {m}_{0} \text{;}$$
8) if Z<ZT, then sending, by the digital signal controller, a stop feeding instruction to the PLC, and controlling, by the PLC, the feeding machine to stop working; automatically switching, by the PLC, the feeding control system to the machine vision, and waiting for the start of the next feeding work.
